(19) United States
(12) Patent Application Publication
(10) Pub. No.: US 2024/0155618 A1
(43) Pub. Date: May 9, 2024

(54) UPLINK CONTROL INFORMATION MULTIPLEXING FOR MULTI-PANEL TRANSMISSION

(71) Applicant: QUALCOMM Incorporated, San Diego, CA (US)

(72) Inventors: Fang YUAN, Beijing (CN); Wooseok NAM, San Diego, CA (US); Tao LUO, San Diego, CA (US)

(21) Appl. No.: 18/550,635

(22) PCT Filed: May 27, 2021
(86) PCT No.: PCT/CN21/96312

§ 371 Date: Sep. 14, 2023

(51) Int. Cl. H04W 72/21; H04B 7/06; H04L 1/00; H04L 1/1829; H04W 72/1268

(52) U.S. Cl. CPC H04W 72/21; H04B 7/0626; H04L 1/0067; H04L 1/1861; H04W 72/1268

(57) ABSTRACT

Various aspects of the present disclosure generally relate to wireless communication. In some aspects, a user equipment (UE) may transmit a first uplink control information (UCI) that is multiplexed in a first physical uplink shared channel (PUSCH) occasion on a first beam of multi-panel simultaneous transmission. The UE may transmit a second UCI that is multiplexed in a second PUSCH occasion on a second beam of the multi-panel simultaneous transmission. Numerous other aspects are described.

### FIELD OF THE DISCLOSURE

Aspects of the present disclosure generally relate to wireless communication and to techniques and apparatuses for uplink control information multiplexing for multi-panel transmission.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” or “forward link” refers to the communication link from the BS to the UE, and “uplink or “reverse link” refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes transmitting a first uplink control information (UCI) that is multiplexed in a first physical uplink shared channel (PUSCH) occasion on a first beam of multi-panel simultaneous transmission, and transmitting a second UCI that is multiplexed in a second PUSCH occasion on a second beam of the multi-panel simultaneous transmission.

In some aspects, a method of wireless communication performed by a base station includes receiving a first UCI that is multiplexed in a first PUSCH occasion on a first beam of multi-panel simultaneous transmission, and receiving a second UCI that is multiplexed in a second PUSCH occasion on a second beam of the multi-panel simultaneous transmission.

In some aspects, a UE for wireless communication includes a memory and one or more processors, coupled to the memory, configured to transmit a first UCI that is multiplexed in a PUSCH occasion on a first beam of multi-panel simultaneous transmission, and transmit a second UCI that is multiplexed in a second PUSCH occasion on a second beam of the multi-panel simultaneous transmission.

In some aspects, a base station for wireless communication includes a memory and one or more processors, coupled to the memory, configured to receive a first UCI that is multiplexed in a first PUSCH occasion on a first beam of multi-panel simultaneous transmission, and receive a second UCI that is multiplexed in a second PUSCH occasion on a second beam of the multi-panel simultaneous transmission.

In some aspects, a non-transitory computer-readable medium storing a set of instructions for wireless communication includes one or more instructions that, when executed by one or more processors of a UE, cause the UE to transmit a first UCI that is multiplexed in a first PUSCH occasion on a first beam of multi-panel simultaneous transmission, and transmit a second UCI that is multiplexed in a second PUSCH occasion on a second beam of the multi-panel simultaneous transmission.

In some aspects, a non-transitory computer-readable medium storing a set of instructions for wireless communication includes one or more instructions that, when executed by one or more processors of a base station, cause the base station to receive a first UCI that is multiplexed in a first PUSCH occasion on a first beam of multi-panel simultaneous transmission, and receive a second UCI that is multiplexed in a second PUSCH occasion on a second beam of the multi-panel simultaneous transmission.

In some aspects, an apparatus for wireless communication includes means for transmitting a first UCI that is multiplexed in a first PUSCH occasion on a first beam of multi-panel simultaneous transmission, and means for transmitting a second UCI that is multiplexed in a second PUSCH occasion on a second beam of the multi-panel simultaneous transmission.

In some aspects, an apparatus for wireless communication includes means for receiving a first UCI that is multiplexed in a first PUSCH occasion on a first beam of multi-panel simultaneous transmission, and means for receiving a second UCI that is multiplexed in a second PUSCH occasion on a second beam of the multi-panel simultaneous transmission.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 illustrates an example logical architecture of a distributed radio access network, in accordance with the present disclosure

FIG. 4 is a diagram illustrating an example of multiple transmit receive point (TRP) communication, in accordance with the present disclosure.

FIG. 5 is a diagram illustrating an example of multiplexing uplink control information (UCI), in accordance with the present disclosure.

FIG. 6 is a diagram illustrating an example of multiplexing UCI, in accordance with the present disclosure.

FIG. 7 is a diagram illustrating an example process performed, for example, by a UE, in accordance with the present disclosure.

FIG. 8 is a diagram illustrating an example process performed, for example, by a base station, in accordance with the present disclosure.

FIGS. 9-10 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

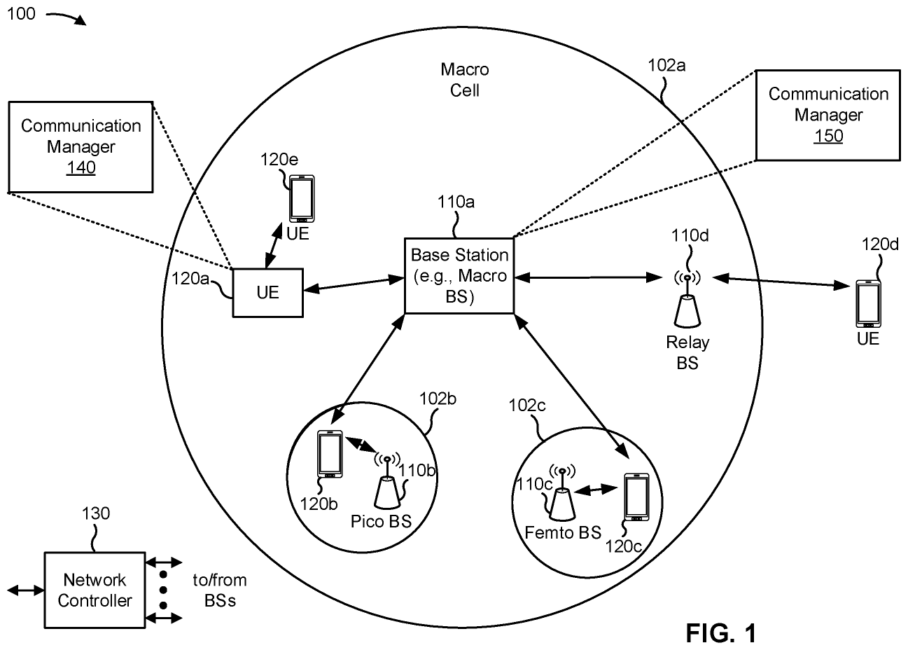

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, the UE 120 may include a communication manager 140. As described in more detail elsewhere herein, the communication manager 140 may transmit a first uplink control information (UCI) that is multiplexed in a first physical uplink shared channel (PUSCH) occasion on a first beam of multi-panel simultaneous transmission and transmit a second UCI that is multiplexed in a second PUSCH occasion on a second beam of the multi-panel simultaneous transmission. Additionally, or alternatively, the communication manager 140 may perform one or more other operations described herein.

In some aspects, the base station 110 may include a communication manager 150. As described in more detail elsewhere herein, the communication manager 150 may receive a first UCI that is multiplexed in a first PUS CH occasion on a first beam of multi-panel simultaneous transmission and receive a second UCI that is multiplexed in a second PUSCH occasion on a second beam of the multi-panel simultaneous transmission. Additionally, or alternatively, the communication manager 150 may perform one or more other operations described herein.

As indicated above, FIG. 1 is provided as an example. Other examples may differ from what is described with regard to FIG. 1.

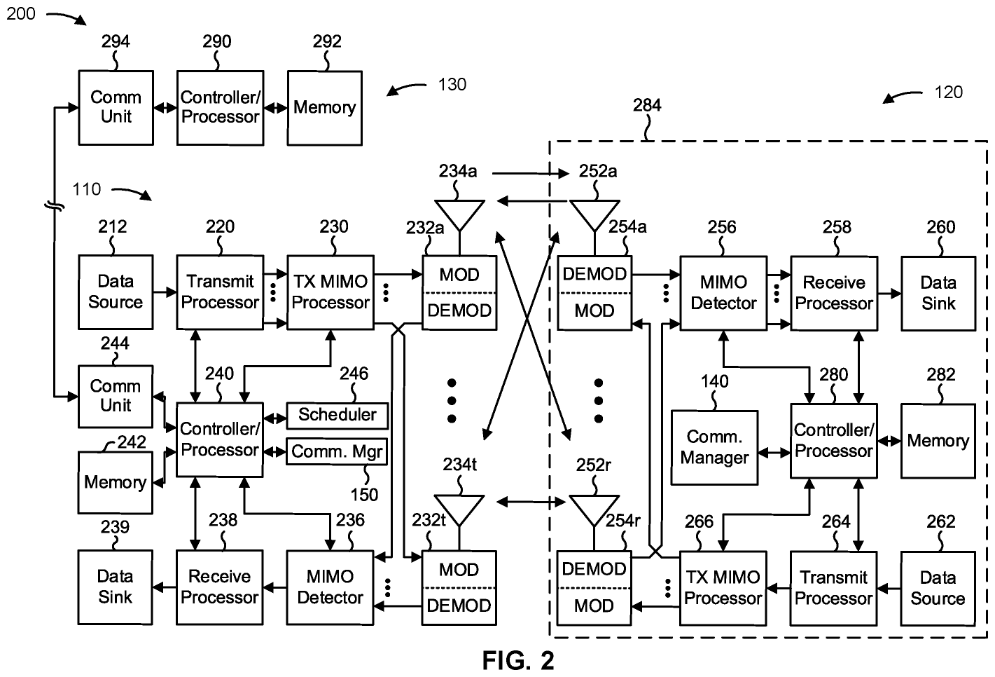

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 1-10).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 1-10).

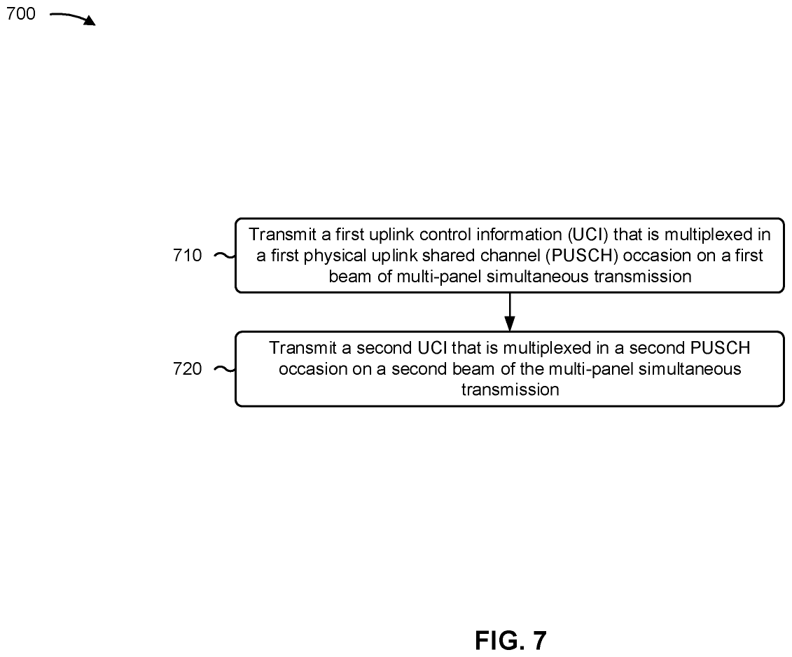

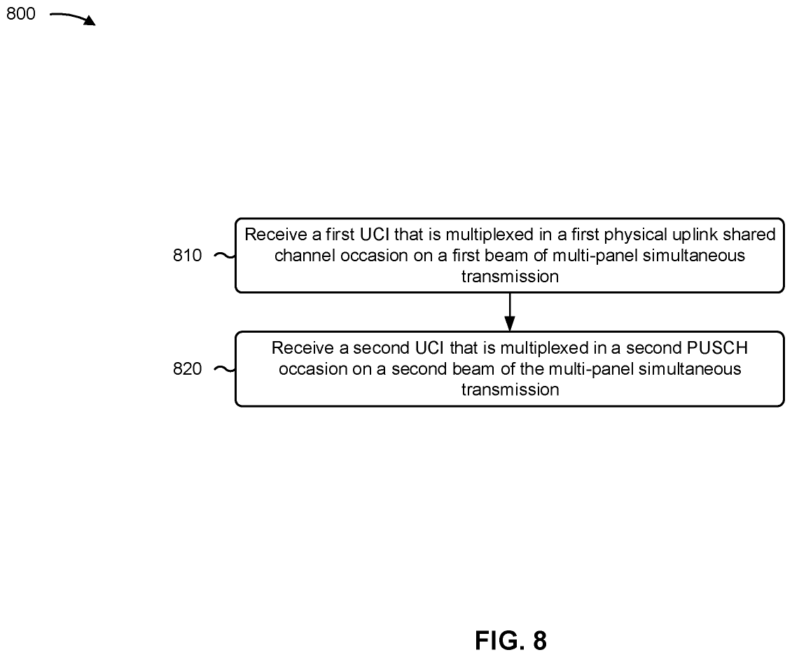

Controller/processor 240 of base station 110, controller/processor 280 of UE 120, and/or any other component(s) of FIG. 2 may perform one or more techniques associated with multiplexing UCI in multiple occasions to multiple TRPs, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some aspects, executing instructions may include running the instructions, converting the instructions, compiling the instructions, and/or interpreting the instructions, among other examples.

In some aspects, the UE 120 includes means for transmitting a first UCI that is multiplexed in a first PUSCH occasion on a first beam of multi-panel simultaneous transmission, and/or means for transmitting a second UCI that is multiplexed in a second PUSCH occasion on a second beam of the multi-panel simultaneous transmission. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the base station 110 includes means for receiving a first UCI that is multiplexed in a first PUSCH occasion on a first beam of multi-panel simultaneous transmission, and/or means for receiving a second UCI that is multiplexed in a second PUSCH occasion on a second beam of the multi-panel simultaneous transmission. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

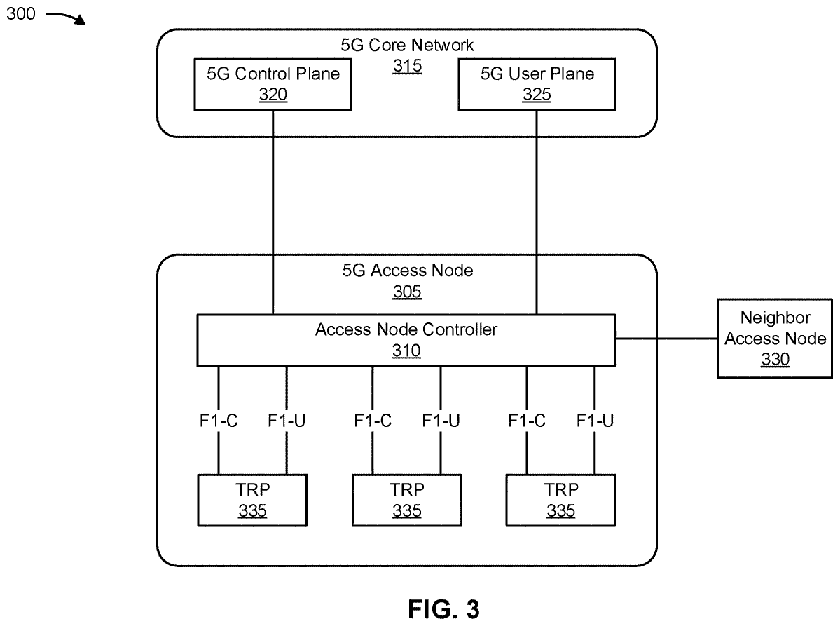

FIG. 3 illustrates an example logical architecture of a distributed radio access network (RAN) 300, in accordance with the present disclosure.

A 5G access node 305 may include an access node controller 310. The access node controller 310 may be a central unit (CU) of the distributed RAN 300. In some aspects, a backhaul interface to a 5G core network 315 may terminate at the access node controller 310. The 5G core network 315 may include a 5G control plane component 320 and a 5G user plane component 325 (e.g., a 5G gateway), and the backhaul interface for one or both of the 5G control plane and the 5G user plane may terminate at the access node controller 310. Additionally, or alternatively, a backhaul interface to one or more neighbor access nodes 330 (e.g., another 5G access node 305 and/or an LTE access node) may terminate at the access node controller 310.

The access node controller 310 may include and/or may communicate with one or more TRPs 335 (e.g., via an F1 Control (F1-C) interface and/or an F1 User (F1-U) interface). A TRP 335 may be a distributed unit (DU) of the distributed RAN 300. In some aspects, a TRP 335 may correspond to a base station 110 described above in connection with FIG. 1. For example, different TRPs 335 may be included in different base stations 110. Additionally, or alternatively, multiple TRPs 335 may be included in a single base station 110. In some aspects, a base station 110 may include a CU (e.g., access node controller 310) and/or one or more DUs (e.g., one or more TRPs 335). In some cases, a TRP 335 may be referred to as a cell, a panel, an antenna array, or an array.

A TRP 335 may be connected to a single access node controller 310 or to multiple access node controllers 310. In some aspects, a dynamic configuration of split logical functions may be present within the architecture of distributed RAN 300. For example, a packet data convergence protocol (PDCP) layer, a radio link control (RLC) layer, and/or a medium access control (MAC) layer may be configured to terminate at the access node controller 310 or at a TRP 335.

In some aspects, multiple TRPs 335 may transmit communications (e.g., the same communication or different communications) in the same transmission time interval (TTI) (e.g., a slot, a mini-slot, a subframe, or a symbol) or different TTIs using different quasi-co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 335 may be configured to individually (e.g., using dynamic selection) or jointly (e.g., using joint transmission with one or more other TRPs 335) serve traffic to a UE 120.

As indicated above, FIG. 3 is provided as an example. Other examples may differ from what was described with regard to FIG. 3.

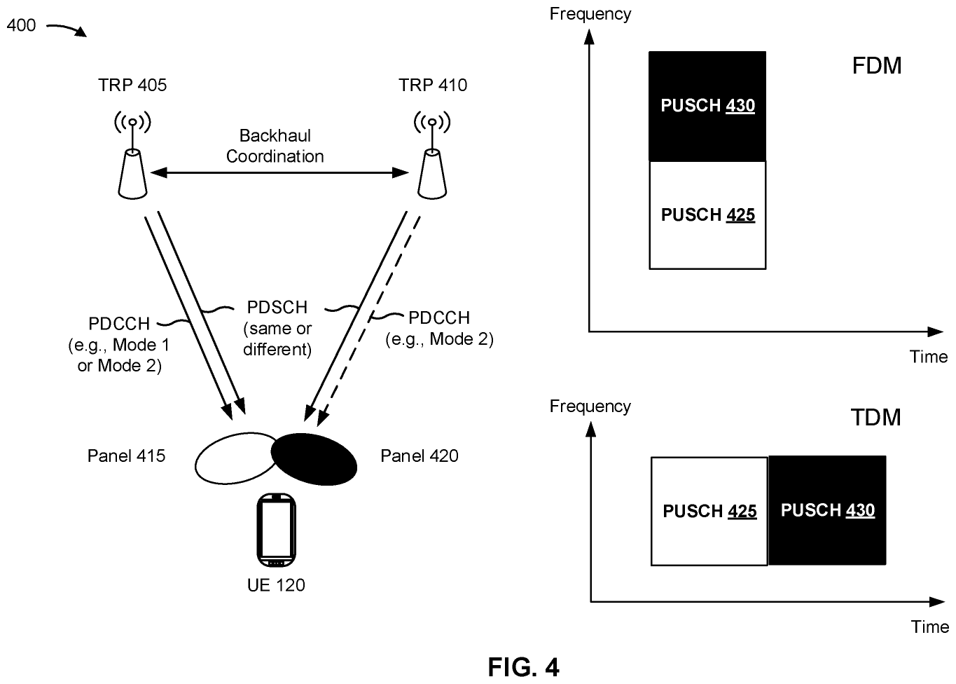

FIG. 4 is a diagram illustrating an example 400 of multi-TRP communication (sometimes referred to as multi-panel communication), in accordance with the present disclosure. As shown in FIG. 4, multiple TRPs, such as TRP 405 and TRP 410, may communicate with the same UE 120. TRP 405 and TRP 410 may correspond to a TRP 335 described above in connection with FIG. 3.

TRP 40 and TRP 410 may communicate with the same UE 120 in a coordinated manner (e.g., using coordinated multipoint transmissions) to improve reliability and/or increase throughput. TRP 405 and TRP 410 may coordinate such communications via an interface between TRP 405 and TRP 410 (e.g., a backhaul interface and/or an access node controller 310). The interface may have a smaller delay and/or higher capacity when TRP 405 and TRP 410 are co-located at the same base station 110 (e.g., when TRP 405 and TRP 410 are different antenna arrays or panels of the same base station 110), and may have a larger delay and/or lower capacity (as compared to co-location) when TRP 405 and TRP 410 are located at different base stations 110. TRP 405 and TRP 410 may communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, TRP 405 and TRP 410 may transmit communications to the UE 120 on the same PDSCH. For example, a communication may be transmitted using a single codeword with different spatial layers for TRP 405 and TRP 410 (e.g., where one codeword maps to a first set of layers transmitted by TRP 405 and maps to a second set of layers transmitted by a second TRP 410). As another example, a communication may be transmitted using multiple codewords, where different codewords are transmitted by TRP 405 and TRP 410 (e.g., using different sets of layers). In either case, TRP 405 and TRP 410 may use different QCL relationships (e.g., different TCI states) for different DMRS ports corresponding to different layers. For example, TRP 405 may use a first QCL relationship or a first TCI state for a first set of DMRS ports corresponding to a first set of layers, and TRP 410 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by TRP 405, and a second PDCCH may schedule a second codeword to be transmitted by TRP 410. Furthermore, first DCI (e.g., transmitted by TRP 405) may schedule a first PDSCH communication associated with a first set of DMRS ports with a first QCL relationship (e.g., indicated by a first TCI state) for TRP 405, and second DCI (e.g., transmitted by TRP 410) may schedule a second PDSCH communication associated with a second set of DMRS ports with a second QCL relationship (e.g., indicated by a second TCI state) for TRP 410. In this case, DCI (e.g., having DCI format 1_0 or DCI format 1_1) may indicate a corresponding TCI state for TRP 405 or TRP 410 corresponding to the DCI. The TCI field of a DCI indicates the corresponding TCI state (e.g., the TCI field of the first DCI indicates the first TCI state and the TCI field of the second DCI indicates the second TCI state).

UE 120 may be configured to use multiple antenna panels, including panel 415 and panel 420. Panel 415 may form a first beam in the direction of TRP 405, and panel 420 may form a second beam in the direction of TRP 410. Panel 415 and panel 420 may select beams based on beam sweeping. The first beam may have a first spatial relation information or a first TCI, and the second beam may have a second spatial relation information or a second TCI. The beam indication may be indicated by a TCI field or a sounding reference signal (SRS) resource indicator (SRI) in the scheduling DCI. For codebook-based uplink MIMO transmission, panel 415 may use a first transmit precoding matrix index (TPMI), and panel 420 may use a second TPMI, where each TPMI provides a precoder indication for uplink MIMO transmission to a PUSCH occasion. For non-codebook based uplink MIMO transmission, panel 415 may use a first SRI, and panel 420 may use a second SRI, where each SRI provides a precoder indication for uplink MIMO transmission to a PUSCH occasion. Panel 415 may transmit a first SRS from a first SRS resource set that is associated with the first PUSCH occasion, and panel 420 may transmit a second SRS from a second SRS resource set that is associated with the second PUSCH occasion.

UE 120 may transmit a PUSCH communication in a first PUSCH occasion 425 to TRP 405 using panel 415 and transmit a PUSCH communication in a second PUSCH occasion 430 to TRP 410 using panel 420. UE 120 may transmit the PUSCH communications using frequency division multiplexing (FDM). For example, the first PUSCH occasion 425 and the second PUSCH occasions may have a same time duration (or time domain resource allocation) but may be in different frequency domain resource allocations (FDRAs) or frequencies. A transport block (TB) or codeword on the PUSCH may be mapped consecutively to an FDRA or to the different parts of FDRA with different redundancy versions (RVs). UE 120 may also transmit communications using time division multiplexing (TDM), where the first PUSCH occasion 425 and the second PUSCH occasion 430 are in the same FDRA or frequency but in consecutive TTIs or slots.

The UE 120 may transmit UCI on a physical uplink control channel (PUCCH). In some scenarios, the PUCCH may overlap with the PUSCH, or the UE 120 may transmit the UCI on the PUS CH. The UCI may be multiplexed with data on the PUSCH.

As indicated above, FIG. 4 is provided as an example. Other examples may differ from what is described with respect to FIG. 4.

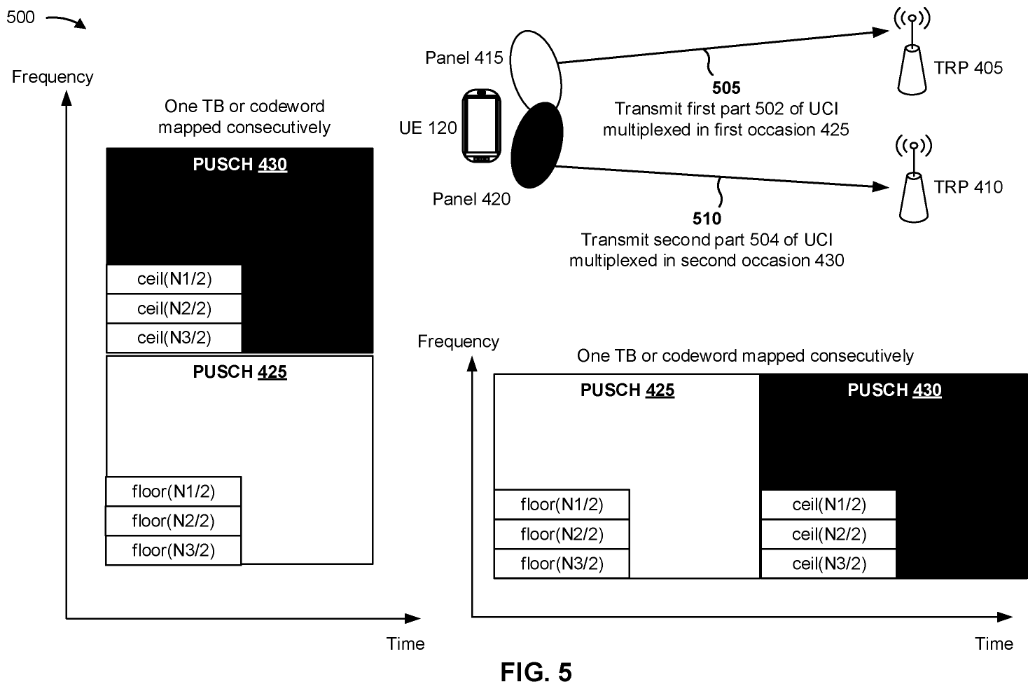

FIG. 5 is a diagram illustrating an example 500 of multiplexing UCI, in accordance with the present disclosure. Example 500 shows that UE 120 may communicate with TRP 405 and TRP 410. TRP 405 and TRP 410 may communicate with each other over a backhaul or may be part of the same base station.

According to various aspects described herein, a UE may improve the efficiency and/or reliability of multiplexed UCI transmissions in a multi-panel scenario, including for FDM or for TDM. The UE 120 may transmit PUSCH occasion 425 and PUSCH occasion 430 with different beams. The UE 120 may split UCI into two parts. As shown by reference number 505, the UE 120 may transmit a first part of the UCI multiplexed in PUSCH occasion 425. As shown by reference number 510, the UE 120 may transmit a second part of the UCI multiplexed in PUSCH occasion 430. The UCI may be multiplexed in consecutive TBs or codewords. As shown by example 500, PUSCH occasion 425 and PUSCH occasion 430 may be consecutive occasions in FDM or in TDM. In some aspects, the UCI may be split between two or more PUSCH occasions if the two or more PUSCH occasions are transmitted using a single rate matching. Rate matching includes matching data bits to TBs at a specific data rate.

In some aspects, the UCI may include N modulation symbols, and the UE 120 may partition the N modulation symbols into multiple PUSCH occasions, such as into PUSCH occasion 425 and PUSCH occasion 430. For example, the UCI may be or may include a hybrid automatic repeat request (HARQ) acknowledgment (ACK). The UE 120 may partition N1 modulation symbols of the HARQ-ACK into HARQ-ACK part A and HARQ-ACK part B, where part A has a lower half (e.g., floor(N1/2)) and part B has an upper half (e.g., ceiling(N1/2)) of the N1 modulation symbols. HARQ-ACK part A may be mapped to PUSCH occasion 425, and HARQ-ACK part B may be mapped to PUSCH occasion 430.

In some aspects, the UCI may be or may include channel state information (CSI) part 1. The UE 120 may partition N2 modulation symbols of the CSI part 1 into CSI part 1A and CSI part 1B, where part 1A has a lower half (e.g., floor(N2/2)) and part 1B has an upper half (e.g., ceiling(N2/2)) of the N2 modulation symbols for the CSI part 1. CSI part 1A may be mapped to PUSCH occasion 425, and CSI part 1B may be mapped to PUSCH occasion 430.

In some aspects, the UCI may be or may include CSI part 2. The UE 120 may partition N3 modulation symbols of the CSI part 2 into CSI part 2A and CSI part 2B, where part 2A has a lower half (e.g., floor(N3/2)) and part 2B has an upper half (e.g., ceiling(N3/2)) modulation symbols. CSI part 2A may be mapped to PUSCH occasion 425, and CSI part 2B may be mapped to PUSCH occasion 430. Note that other types of control information may be split into multiple PUSCH occasions, and the fraction of the modulation symbols in each PUSCH occasion may depend on how many PUSCH occasions the UCI is spread across.

By splitting the UCI into multiple PUSCH occasions on multiple beams in a multi-TRP scenario, the UE 120 may efficiently transmit the UCI to multiple TRPs. As are result, the UE 120 may conserve signaling resources.

As indicated above, FIG. 5 is provided as an example. Other examples may differ from what is described with regard to FIG. 5.

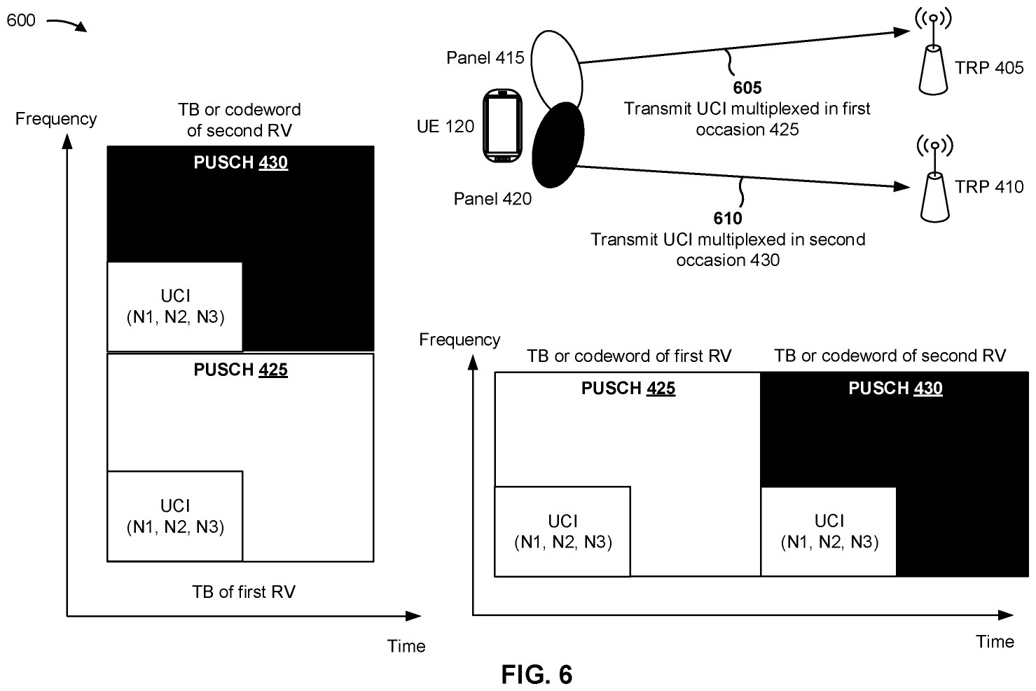

FIG. 6 is a diagram illustrating an example 600 of multiplexing UCI, in accordance with the present disclosure. Example 600 shows that the UE 120 may communicate with TRP 405 and TRP 410. TRP 405 and TRP 410 may communicate with each other over a backhaul or may be part of a same base station (e.g., base station 110).

In some aspects, the UE 120 may multiplex a first repetition of the UCI in PUSCH occasion 425 and a second repetition in PUSCH occasion 430. The UCI may be in multiplexed in consecutive TBs or codewords. The same TB to be transmitted in the PUSCH occasion 425 and 430 may be indicated with same or different RV values. As shown by example 600, PUSCH occasion 425 and PUSCH occasion 430 may be consecutive occasions in FDM or in TDM. In some aspects, the UCI may be repeated in two or more PUSCH occasions if the two or more PUSCH occasions are transmitted with separate or different rate matching.

In some aspects, the UCI may be transmitted in N modulation symbols. The N modulation symbols may include, for example, a HARQ-ACK, CSI part 1, and/or CSI part 2. The N modulation symbols may include other control information. As shown by reference number 605, the UE 120 may transmit the UCI multiplexed in PUSCH occasion 425. As shown by reference number 610, the UE 120 may transmit the same UCI multiplexed in PUSCH occasion 430.

As shown by example 600, the UE 120 may map N1 modulation symbols of the HARQ-ACK to PUSCH occasion 425 and map the same N1 modulation symbols of the HARQ-ACK to PUSCH occasion 430. The UE 120 may map N2 modulation symbols of the CSI part 1 to PUSCH occasion 425 and map the same N2 modulation symbols of the CSI part 1 to PUSCH occasion 430. The UE 120 may map N3 modulation symbols of the CSI part 2 to PUSCH occasion 425 and map the same N3 modulation symbols of the HARQ-ACK to PUSCH occasion 430.

In some aspects, TRP 405 may receive a part first of the UCI and TRP 410 may receive a second part of the UCI and the two parts may be combined later by TRP 405, TRP 410, or a base station associated with TRP 405 and TRP 410. TRP 405 or TRP 410 may receive both parts or TRP 405 and TRP 410 may each receive both parts.

By repeating the UCI into multiple PUSCH occasions on multiple beams in a multi-TRP scenario, the UE 120 may more reliably deliver the UCI to TRPs. As a result, the UE 120 may conserve processing resources and signaling resources that would otherwise be consumed by retransmissions of the UCI.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with multiplexing UCI in multiple PUSCH occasions for multiple TRPs.

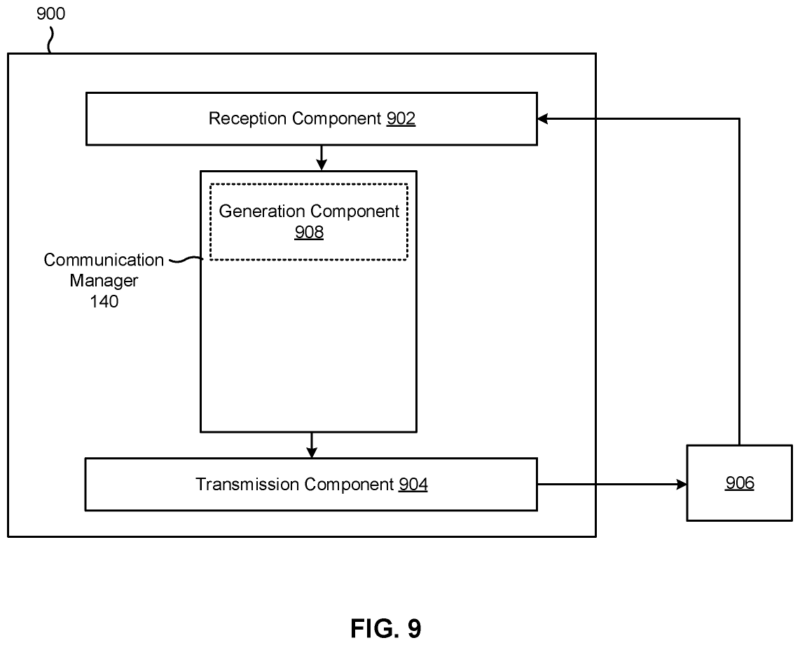

As shown in FIG. 7, in some aspects, process 700 may include transmitting a first UCI that is multiplexed in a first PUS CH occasion on a first beam of multi-panel simultaneous transmission (block 710). For example, the UE (e.g., using communication manager 140 and/or transmission component 904 depicted in FIG. 9) may transmit a first UCI that is multiplexed in a first PUSCH occasion on a first beam of multi-panel simultaneous transmission, as described above. Simultaneous transmission may include transmissions to multiple TRPs while connected to multiple TRPs. This may include some transmissions to different TRPs at the same time or in the same TTI (e.g., slot), consecutive transmissions to different TRPs, transmissions of the same UCI to different TRPs, or transmissions to different TRPs that are otherwise close in time or associated with each other.

As further shown in FIG. 7, in some aspects, process 700 may include transmitting a second UCI that is multiplexed in a second PUSCH occasion on a second beam of the multi-panel simultaneous transmission (block 720). For example, the UE (e.g., using communication manager 140 and/or transmission component 904 depicted in FIG. 9) may transmit a second UCI that is multiplexed in a second PUSCH occasion on a second beam of the multi-panel simultaneous transmission, as described above.

Process 700 may include additional aspects, such as any single aspect or any combination of aspects described below and/or in connection with one or more other processes described elsewhere herein.

In a first aspect, the first UCI and the second UCI are split portions of a same UCI.

In a second aspect, alone or in combination with the first aspect, the same UCI includes a HARQ-ACK, and the first UCI includes modulation symbols of a first part of the HARQ-ACK and the second UCI includes modulation symbols of a second part of the HARQ-ACK.

In a third aspect, alone or in combination with one or more of the first and second aspects, the same UCI includes a CSI part 1, and the first UCI includes modulation symbols of a first part of the CSI part 1 and the second UCI includes modulation symbols of a second part of the CSI part 1.

In a fourth aspect, alone or in combination with one or more of the first through third aspects, the same UCI includes a CSI part 2, and the first UCI includes modulation symbols of a first part of the CSI part 2 and the second UCI includes modulation symbols of a second part of the CSI part 2.

In a fifth aspect, alone or in combination with one or more of the first through fourth aspects, the first UCI and the second UCI are split portions of the same UCI based at least in part on the first PUSCH occasion and the second PUSCH occasion being transmitted using single rate matching.

In a sixth aspect, alone or in combination with one or more of the first through fifth aspects, the first UCI and the second UCI are repetitions of the same UCI.

In a seventh aspect, alone or in combination with one or more of the first through sixth aspects, the same UCI includes a HARQ-ACK, and the first UCI includes modulation symbols of the HARQ-ACK and the second UCI includes the modulation symbols of the HARQ-ACK.

In an eighth aspect, alone or in combination with one or more of the first through seventh aspects, the same UCI includes a CSI part 1, and the first UCI includes modulation symbols of the CSI part 1 and the second UCI includes the modulation symbols of the CSI part 1.

In a ninth aspect, alone or in combination with one or more of the first through eighth aspects, the same UCI includes a CSI part 2, and the first UCI includes modulation symbols of the CSI part 2 and the second UCI includes the modulation symbols of the CSI part 2.

In a tenth aspect, alone or in combination with one or more of the first through ninth aspects, the first UCI and the second UCI are repetitions of the same UCI based at least in part on a rate matching used to transmit the first PUSCH occasion being different than a rate matching used to transmit the second PUSCH occasion.

In an eleventh aspect, alone or in combination with one or more of the first through tenth aspects, the first PUSCH occasion and the second PUSCH occasion are FDMed.

In a twelfth aspect, alone or in combination with one or more of the first through eleventh aspects, the first PUSCH occasion and the second PUSCH occasion are TDMed.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with receiving UCI that is multiple PUSCH occasions.

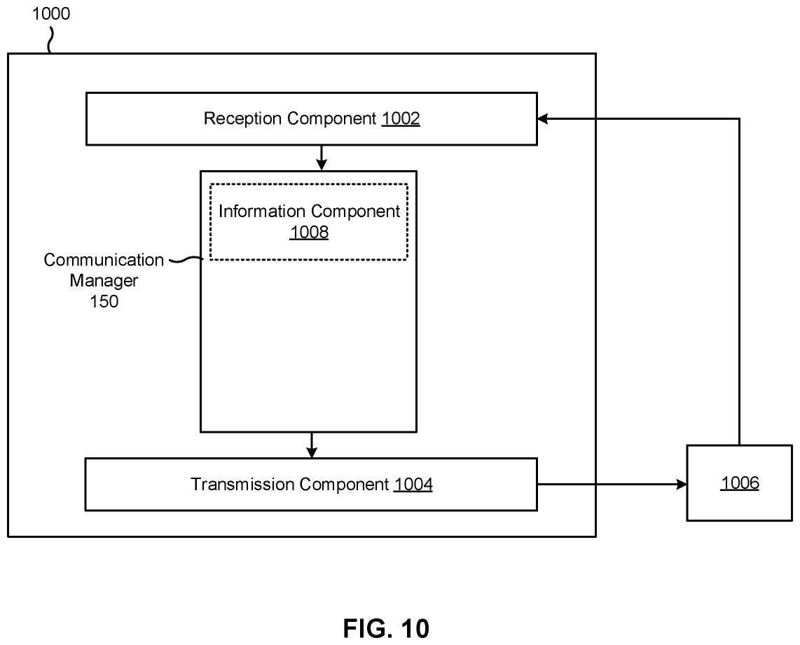

As shown in FIG. 8, in some aspects, process 800 may include receiving a first UCI that is multiplexed in a first PUSCH occasion on a first beam of multi-panel simultaneous transmission (block 810). For example, the base station (e.g., using communication manager 150 and/or reception component 1002 depicted in FIG. 10) may receive a first UCI that is multiplexed in a first PUSCH occasion on a first beam of multi-panel simultaneous transmission, as described above.

As further shown in FIG. 8, in some aspects, process 800 may include receiving a second UCI that is multiplexed in a second PUSCH occasion on a second beam of the multi-panel simultaneous transmission (block 820). For example, the base station (e.g., using communication manager 150 and/or reception component 1002 depicted in FIG. 10) may receive a second UCI that is multiplexed in a second PUSCH occasion on a second beam of the multi-panel simultaneous transmission, as described above.

Process 800 may include additional aspects, such as any single aspect or any combination of aspects described below and/or in connection with one or more other processes described elsewhere herein.

In a first aspect, the first UCI and the second UCI are split portions of a same UCI.

In a second aspect, alone or in combination with the first aspect, the same UCI includes a HARQ-ACK, and the first UCI includes modulation symbols of a first part of the HARQ-ACK and the second UCI includes modulation symbols of a second part of the HARQ-ACK.

In a third aspect, alone or in combination with one or more of the first and second aspects, the same UCI includes a CSI part 1, and the first UCI includes modulation symbols of a first part of the CSI part 1 and the second UCI includes modulation symbols of a second part of the CSI part 1.

In a fourth aspect, alone or in combination with one or more of the first through third aspects, the same UCI includes a CSI part 2, and the first UCI includes modulation symbols of a first part of the CSI part 2 and the second UCI includes modulation symbols of a second part of the CSI part 2.

In a fifth aspect, alone or in combination with one or more of the first through fourth aspects, the first UCI and the second UCI are split portions of the same UCI based at least in part on the first PUSCH occasion and the second PUSCH occasion being received using single rate matching.

In a sixth aspect, alone or in combination with one or more of the first through fifth aspects, the first UCI and the second UCI are repetitions of the same UCI.

In a seventh aspect, alone or in combination with one or more of the first through sixth aspects, the same UCI includes a HARQ-ACK, and the first UCI includes modulation symbols of the HARQ-ACK and the second UCI includes the modulation symbols of the HARQ-ACK.

In an eighth aspect, alone or in combination with one or more of the first through seventh aspects, the same UCI includes a CSI part 1, and the first UCI includes modulation symbols of the CSI part 1 and the second UCI includes the modulation symbols of the CSI part 1.

In a ninth aspect, alone or in combination with one or more of the first through eighth aspects, the same UCI includes a CSI part 2, and the first UCI includes modulation symbols of the CSI part 2 and the second UCI includes the modulation symbols of the CSI part 2.

In a tenth aspect, alone or in combination with one or more of the first through ninth aspects, the first UCI and the second UCI are repetitions of the same UCI based at least in part on a rate matching used to receive the first PUSCH occasion being different than a rate matching used to receive the second PUSCH occasion.

In an eleventh aspect, alone or in combination with one or more of the first through tenth aspects, the first PUSCH occasion and the second PUSCH occasion are FDMed.

In a twelfth aspect, alone or in combination with one or more of the first through eleventh aspects, the first PUSCH occasion and the second PUSCH occasion are TDMed.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a block diagram of an example apparatus 900 for wireless communication. The apparatus 900 may be a UE (e.g., UE 120), or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a TRP, a base station, or another wireless communication device) using the reception component 902 and the transmission component 904. As further shown, the apparatus 900 may include the communication manager 140. The communication manager 140 may include a generation component 908, among other examples.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The generation component 908 may generate UCI, which may include feedback. The generation component 908 may split the UCI for transmission in multiple uplink occasions, including in multiple PUCCH occasions or multiple PUSCH occasions. The transmission component 904 may transmit a first UCI that is multiplexed in a first PUSCH occasion on a first beam of multi-panel simultaneous transmission. The transmission component 904 may transmit a second UCI that is multiplexed in a second PUSCH occasion on a second beam of the multi-panel simultaneous transmission.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a block diagram of an example apparatus 1000 for wireless communication. The apparatus 1000 may be a base station (e.g., base station 110) or TRP (e.g., TRP 405, TRP 410), or a base station or TRP may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include an information component 1008, among other examples.

In some aspects, the apparatus 1000 may be configured to perform one or more operations described herein in connection with FIGS. 1-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the base station described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the base station described in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the base station described in connection with FIG. 2. In some aspects, the transmission component 1004 may be co-located with the reception component 1002 in a transceiver.

The reception component 1002 may receive a first UCI that is multiplexed in a first PUSCH occasion on a first beam of multi-panel simultaneous transmission. The reception component 1002 may receive a second UCI that is multiplexed in a second PUSCH occasion on a second beam of the multi-panel simultaneous transmission. The information component 1008 may combine and/or utilize UCI that was multiplexed in multiple occasions (e.g., PUSCH occasions).

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: transmitting a first uplink control information (UCI) that is multiplexed in a first physical uplink shared channel (PUSCH) occasion on a first beam of multi-panel simultaneous transmission; and transmitting a second UCI that is multiplexed in a second PUSCH occasion on a second beam of the multi-panel simultaneous transmission.

Aspect 2: The method of Aspect 1, wherein the first UCI and the second UCI are split portions of a same UCI.

Aspect 3: The method of Aspect 2, wherein the same UCI includes a hybrid automatic repeat request (HARQ) acknowledgement (ACK), and wherein the first UCI includes modulation symbols of a first part of the HARQ-ACK and the second UCI includes modulation symbols of a second part of the HARQ-ACK.

Aspect 4: The method of Aspect 2 or 3, wherein the same UCI includes a channel state information (CSI) part 1, and wherein the first UCI includes modulation symbols of a first part of the CSI part 1 and the second UCI includes modulation symbols of a second part of the CSI part 1.

Aspect 5: The method of any of Aspects 2-4, wherein the same UCI includes a channel state information (CSI) part 2, and wherein the first UCI includes modulation symbols of a first part of the CSI part 2 and the second UCI includes modulation symbols of a second part of the CSI part 2.

Aspect 6: The method of any of Aspects 2-5, wherein the first UCI and the second UCI are split portions of the same UCI based at least in part on the first PUSCH occasion and the second PUSCH occasion being transmitted using single rate matching.

Aspect 7: The method of Aspect 1, wherein the first UCI and the second UCI are repetitions of the same UCI.

Aspect 8: The method of Aspect 7, wherein the same UCI includes a hybrid automatic repeat request (HARQ) acknowledgement (ACK), and wherein the first UCI includes modulation symbols of the HARQ-ACK and the second UCI includes the modulation symbols of the HARQ-ACK.

Aspect 9: The method of Aspect 7 or 8, wherein the same UCI includes a channel state information (CSI) part 1, and wherein the first UCI includes modulation symbols of the CSI part 1 and the second UCI includes the modulation symbols of the CSI part 1.

Aspect 10: The method of any of Aspects 7-9, wherein the same UCI includes a channel state information (CSI) part 2, and wherein the first UCI includes modulation symbols of the CSI part 2 and the second UCI includes the modulation symbols of the CSI part 2.

Aspect 11: The method of any of Aspects 7-10, wherein the first UCI and the second UCI are repetitions of the same UCI based at least in part on a rate matching used to transmit the first PUSCH occasion being different than a rate matching used to transmit the second PUSCH occasion.

Aspect 12: The method of any of Aspects 1-11, wherein the first PUSCH occasion and the second PUSCH occasion are frequency division multiplexed.

Aspect 13: The method of any of Aspects 1-12, wherein the first PUSCH occasion and the second PUSCH occasion are time division multiplexed.

Aspect 14: A method of wireless communication performed by a base station, comprising: receiving a first uplink control information (UCI) that is multiplexed in a first physical uplink shared channel (PUSCH) occasion on a first beam of multi-panel simultaneous transmission; and receiving a second UCI that is multiplexed in a second PUSCH occasion on a second beam of the multi-panel simultaneous transmission.

Aspect 15: The method of Aspect 14, wherein the first UCI and the second UCI are split portions of a same UCI.

Aspect 16: The method of Aspect 15, wherein the same UCI includes a hybrid automatic repeat request (HARQ) acknowledgement (ACK), and wherein the first UCI includes modulation symbols of a first part of the HARQ-ACK and the second UCI includes modulation symbols of a second part of the HARQ-ACK.

Aspect 17: The method of Aspect 15 or 16, wherein the same UCI includes a channel state information (CSI) part 1, and wherein the first UCI includes modulation symbols of a first part of the CSI part 1 and the second UCI includes modulation symbols of a second part of the CSI part 1.

Aspect 18: The method of any of Aspects 15-17, wherein the same UCI includes a channel state information (CSI) part 2, and wherein the first UCI includes modulation symbols of a first part of the CSI part 2 and the second UCI includes modulation symbols of a second part of the CSI part 2.

Aspect 19: The method of any of Aspects 15-18, wherein the first UCI and the second UCI are split portions of the same UCI based at least in part on the first PUSCH occasion and the second PUSCH occasion being received using single rate matching.

Aspect 20: The method of Aspect 14, wherein the first UCI and the second UCI are repetitions of the same UCI.

Aspect 21: The method of Aspect 20, wherein the same UCI includes a hybrid automatic repeat request (HARQ) acknowledgement (ACK), and wherein the first UCI includes modulation symbols of the HARQ-ACK and the second UCI includes the modulation symbols of the HARQ-ACK.

Aspect 22: The method of Aspect 20 or 21, wherein the same UCI includes a channel state information (CSI) part 1, and wherein the first UCI includes modulation symbols of the CSI part 1 and the second UCI includes the modulation symbols of the CSI part 1.

Aspect 23: The method of any of Aspects 20-22, wherein the same UCI includes a channel state information (CSI) part 2, and wherein the first UCI includes modulation symbols of the CSI part 2 and the second UCI includes the modulation symbols of the CSI part 2.

Aspect 24: The method of any of Aspects 20-23, wherein the first UCI and the second UCI are repetitions of the same UCI based at least in part on a rate matching used to receive the first PUSCH occasion being different than a rate matching used to receive the second PUSCH occasion.

Aspect 25: The method of any of Aspects 14-24, wherein the first PUSCH occasion and the second PUSCH occasion are frequency division multiplexed.

Aspect 26: The method of any of Aspects 14-25, wherein the first PUSCH occasion and the second PUSCH occasion are time division multiplexed.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit a first uplink control information (UCI) that is multiplexed in a first physical uplink shared channel (PUSCH) occasion on a first beam of multi-panel simultaneous transmission; and
transmit a second UCI that is multiplexed in a second PUSCH occasion on a second beam of the multi-panel simultaneous transmission.

2. The UE of claim 1, wherein the first UCI and the second UCI are split portions of a same UCI.

3. The UE of claim 2, wherein the same UCI includes a hybrid automatic repeat request (HARQ) acknowledgement (ACK), and wherein the first UCI includes modulation symbols of a first part of the HARQ-ACK and the second UCI includes modulation symbols of a second part of the HARQ-ACK.

4. The UE of claim 2, wherein the same UCI includes a channel state information (CSI) part 1, and wherein the first UCI includes modulation symbols of a first part of the CSI part 1 and the second UCI includes modulation symbols of a second part of the CSI part 1.

5. The UE of claim 2, wherein the same UCI includes a channel state information (CSI) part 2, and wherein the first UCI includes modulation symbols of a first part of the CSI part 2 and the second UCI includes modulation symbols of a second part of the CSI part 2.

6. The UE of claim 2, wherein the first UCI and the second UCI are split portions of the same UCI based at least in part on the first PUSCH occasion and the second PUSCH occasion being transmitted using single rate matching.

7. The UE of claim 1, wherein the first UCI and the second UCI are repetitions of the same UCI.

8. The UE of claim 7, wherein the same UCI includes a hybrid automatic repeat request (HARQ) acknowledgement (ACK), and wherein the first UCI includes modulation symbols of the HARQ-ACK and the second UCI includes the modulation symbols of the HARQ-ACK.

9. The UE of claim 7, wherein the same UCI includes a channel state information (CSI) part 1, and wherein the first UCI includes modulation symbols of the CSI part 1 and the second UCI includes the modulation symbols of the CSI part 1.

10. The UE of claim 7, wherein the same UCI includes a channel state information (CSI) part 2, and wherein the first UCI includes modulation symbols of the CSI part 2 and the second UCI includes the modulation symbols of the CSI part 2.

11. The UE of claim 7, wherein the first UCI and the second UCI are repetitions of the same UCI based at least in part on a rate matching used to transmit the first PUSCH occasion being different than a rate matching used to transmit the second PUSCH occasion.

12. The UE of claim 1, wherein the first PUSCH occasion and the second PUSCH occasion are frequency division multiplexed.

13. The UE of claim 1, wherein the first PUSCH occasion and the second PUSCH occasion are time division multiplexed.

14. A base station for wireless communication, comprising:
a memory; and
one or more processors, coupled to the memory, configured to:
receive a first uplink control information (UCI) that is multiplexed in a first physical uplink shared channel (PUSCH) occasion on a first beam of multi-panel simultaneous transmission; and
receive a second UCI that is multiplexed in a second PUSCH occasion on a second beam of the multi-panel simultaneous transmission.

15. The base station of claim 14, wherein the first UCI and the second UCI are split portions of a same UCI.

16. The base station of claim 15, wherein the same UCI includes a hybrid automatic repeat request (HARQ) acknowledgement (ACK), and wherein the first UCI includes modulation symbols of a first part of the HARQ-ACK and the second UCI includes modulation symbols of a second part of the HARQ-ACK.

17. The base station of claim 15, wherein the same UCI includes a channel state information (CSI) part 1, and wherein the first UCI includes modulation symbols of a first part of the CSI part 1 and the second UCI includes modulation symbols of a second part of the CSI part 1.

18. The base station of claim 15, wherein the same UCI includes a channel state information (CSI) part 2, and wherein the first UCI includes modulation symbols of a first part of the CSI part 2 and the second UCI includes modulation symbols of a second part of the CSI part 2.

19. The base station of claim 15, wherein the first UCI and the second UCI are split portions of the same UCI based at least in part on the first PUSCH occasion and the second PUSCH occasion being received using single rate matching.

20. The base station of claim 14, wherein the first UCI and the second UCI are repetitions of the same UCI.

21. The base station of claim 20, wherein the same UCI includes a hybrid automatic repeat request (HARQ) acknowledgement (ACK), and wherein the first UCI includes modulation symbols of the HARQ-ACK and the second UCI includes the modulation symbols of the HARQ-ACK.

22. The base station of claim 20, wherein the same UCI includes a channel state information (CSI) part 1, and wherein the first UCI includes modulation symbols of the CSI part 1 and the second UCI includes the modulation symbols of the CSI part 1.

23. The base station of claim 20, wherein the same UCI includes a channel state information (CSI) part 2, and wherein the first UCI includes modulation symbols of the CSI part 2 and the second UCI includes the modulation symbols of the CSI part 2.

24. The base station of claim 20, wherein the first UCI and the second UCI are repetitions of the same UCI based at least in part on a rate matching used to receive the first PUSCH occasion being different than a rate matching used to receive the second PUSCH occasion.

25. The base station of claim 14, wherein the first PUSCH occasion and the second PUSCH occasion are frequency division multiplexed.

26. The base station of claim 14, wherein the first PUSCH occasion and the second PUSCH occasion are time division multiplexed.

27. A method of wireless communication performed by a user equipment (UE), comprising:
transmitting a first uplink control information (UCI) that is multiplexed in a first physical uplink shared channel (PUSCH) occasion on a first beam of multi-panel simultaneous transmission; and
transmitting a second UCI that is multiplexed in a second PUSCH occasion on a second beam of the multi-panel simultaneous transmission.

28. The method of claim 27, wherein the first UCI and the second UCI are split portions of a same UCI.

29. The method of claim 27, wherein the first UCI and the second UCI are repetitions of the same UCI.

30. A method of wireless communication performed by a base station, comprising:
receiving a first uplink control information (UCI) that is multiplexed in a first physical uplink shared channel (PUSCH) occasion on a first beam of multi-panel simultaneous transmission; and
receiving a second UCI that is multiplexed in a second PUSCH occasion on a second beam of the multi-panel simultaneous transmission.
